(19) United States
(12) Patent Application Publication
(10) Pub. No.: US 2003/0200193 A1
(43) Pub. Date: Oct. 23, 2003

(54) Fast retrieval of data stored in metadata

(76) Inventor: Michael L. Boucher, Lafayette, CO (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/124,681

(22) Filed: Apr. 17, 2002

(51) Int. Cl. G06F 7/00

(52) U.S. Cl. 707/1

(57) ABSTRACT

A fast access system for data stored in a file system is provided. Because there is typically far less overhead with the fast access system than a conventional file system, the fast access system provides a substantial boost in data access efficiency. File names themselves in the fast access system store data for later retrieval. As a result, the file system may retrieve metadata maintained in the file system, rather than opening the file itself, to obtain the data. Thus, the methods and systems accelerate retrieval of data by avoiding significant overhead that would be required for a conventional file system to open and read data from a file.

### FIELD OF THE INVENTION

This invention relates to data storage and retrieval in data processing systems. In particular, this invention relates to methods and systems for quickly storing and retrieving data from a file system.

### BACKGROUND OF THE INVENTION

Storing and retrieving small amounts of data, particularly from a shared data source, often incurs a relatively large amount of overhead. Thus, the time spent performing overhead operations, for small amounts of data, can often far exceed the time spent actually storing and retrieving the desired data.

In the past, for example, the steps required for a typical file system to read data included: 1) receiving a request from a program that directs the operating system or file system to open a file in accordance with a file name, path, and attributes specified by the request; 2) locating a file table of contents and determining whether the read operation can be executed; 3) updating status data to reflect access to the file, including a counter reflecting the number of programs that have the file open and the time at which the file was most recently accessed, and the like; 4) returning a handle to the program by which the program can quickly refer to the file; 5) preparing, by the program, to operate on the file by updating internal tables that show the state of open files, allocating buffers, and the like; 6) issuing system calls to perform file I/O, including set-position, read, and write calls, and processing those system calls; 7) creating and operating exclusive access devices, if necessary, including mutexes, readers/writer locks, file locks, record locks, and the like; and 8) when the program is done with the file, closing the file, resulting in buffers being flushed, file tables updated, memory deallocated, and the like, both by the program and by the operating system and/or file system.

In an attempt to relieve the inefficiencies associated with retrieving small amounts of data, data processing systems have, in the past, adopted several strategies. One strategy included creating a memory based file system and copying the relevant files into the file system. However, while the memory based file system provided faster access to the data compared to a disk or tape file system, it still incurred all of the overhead enumerated above and further was generally only available to processes sharing a common physical memory. While the memory-based file system strategy can be modified to export the memory based file system for remote mounting, such a modification adds even more overhead to the file access process.

As an additional strategy, prior file systems have tried to tune for particular file I/O characteristics. Thus, for example, a streaming video file could be contiguously placed on a disk. Regardless, the resultant file system still incorporated all of the overhead enumerated above, and further included the overhead required to maintain the file system in a tuned state.

An additional strategy was sometimes used to store one bit of data. In particular, the presence or absence of a file with a preselected name was used to provide one bit of information. Thus, if the file (e.g., “password_list_opened”) existed, a certain condition was assumed true (e.g., someone was editing the password file), and if the file did not exist, the condition was assumed false, for example. Limited to one bit, however, this strategy was not sophisticated enough to store generally useful amounts of data.

Therefore, a need has long existed for a data storage and retrieval technique that overcomes the problems noted above and others previously experienced.

### SUMMARY OF THE INVENTION

Methods and systems consistent with the present invention provide fast access to useful amounts of data stored in a file system. This fast access system typically requires far less overhead than prior file systems. Thus, in storing and retrieving small of amounts of data, the fast access system provides a substantial boost in data access efficiency.

According to one aspect of the present invention, such methods and systems, as embodied and broadly described herein, include creating files with names that (in and of themselves) store the data for later retrieval. As a result, the operating system or file system need only retrieve metadata that includes the file name (such as a table of contents) to obtain the required data. Thus, the methods and systems accelerate storage and retrieval of small amounts of data by avoiding most of the steps that would be required for a conventional file system to read or write data from or to a file.

Methods and systems consistent with the present invention overcome the shortcomings of the related art, for example, by allowing a file service program to store data in a filename. Thus, a file service program need not incur the overhead to create a new file, place the data in the file, and later reopen the file and reread the data. Rather, methods and systems consistent with the present invention may obtain the data without actually opening and reading the file itself.

In accordance with methods consistent with the present invention, a method is provided for storing data. The method includes receiving a request from a program to store predetermined data, forming a file name incorporating the predetermined data, and creating a file with the file name in a memory, whereby the predetermined data is stored in the file name.

In accordance with systems consistent with the present invention, a data processing system is provided. The data processing system includes a memory comprising a file service program, the file service program receiving a request from a program to store predetermined data, forming a file name incorporating the predetermined data, and creating a file with the file name in a memory. The data processing system further includes a processor that runs the file service program.

In accordance with articles of manufacture consistent with the present invention, a computer-readable medium is provided. The computer-readable medium contains instructions that cause a data processing system to perform a method for storing data. The method includes the steps of receiving a request from a program to store predetermined data, forming a file name incorporating the predetermined data, and creating a file with the file name in a memory, whereby the predetermined data is stored in the file name.

Other apparatus, methods, features and advantages of the present invention will be or will become apparent to one with skill in the art upon examination of the following figures and detailed description. It is intended that all such additional systems, methods, features and advantages be included within this description, be within the scope of the present invention, and be protected by the accompanying drawings.

### BRIEF DESCRIPTION OF THE DRAWINGS

FIG. 1 depicts a block diagram of a data processing system suitable for practicing methods and implementing systems consistent with the present invention.

FIG. 2 depicts a flow diagram showing processing performed by the file service program running in the data processing system shown in FIG. 1 in order to store preselected data in a file name.

FIG. 3 depicts an example of file names formed by the file service program running in the data processing system shown in FIG. 1 in order to store preselected data in a file name.

FIG. 4 depicts a flow diagram showing processing performed by the file service program running in the data processing system shown in FIG. 1 in order to read preselected data from a file name.

FIG. 5 depicts an example of a routine that may be used in the data processing system shown in FIG. 1 to store integer data in a file, rather than in a file name.

FIG. 6 depicts an example of a routine that may be used by the file service program running the data processing system shown in FIG. 1 to store integer data in a file name.

### DETAILED DESCRIPTION OF THE INVENTION

Reference will now be made in detail to an implementation in accordance with methods, systems, and products consistent with the present invention as illustrated in the accompanying drawings. The same reference numbers may be used throughout the drawings and the following description to refer to the same or like parts.

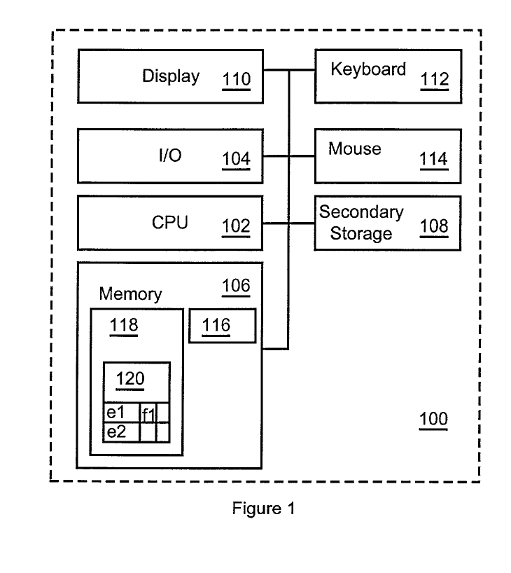

FIG. 1 depicts a block diagram of a data processing system 100 suitable for practicing methods and implementing systems consistent with the present invention. The data processing system 100 comprises a central processing unit (CPU) 102, an input output I/O unit 104, a memory 106, a secondary storage device 108, and a video display 110. The data processing system 100 may further include input devices such as a keyboard 112, a mouse 114 or a speech processor (not illustrated).

The memory 106 contains a program 116 that communicates via message passing, function calls, or the like with a file service program 118. The program 116 represents any program running on the data processing system 100 that stores or retrieves data. As examples, the program 116 may be a word processor, a low level operating system program, or a spreadsheet application. The file service program 118 may be part of an operating system, for example part of a formal file system for conventional fixed disks or RAM disks, or it may comprise a program independent of the operating system. The file service program 118 may also, in some instances, be incorporated into the program 116 as file service routines.

The file service program 118 accesses a data structure 120. The data structure 120, as shown, includes entries (e.g., e1 and e2) that provide fields for storing file system metadata (described in more detail below). Specifically, the fields include a file name field (e.g., f1) that will store a file name that incorporates at least a portion of data to be stored. In other words, the file name itself, rather than the file, will store data identified by the program 116.

Although aspects of the present invention are depicted as being stored in memory 106, one skilled in the art will appreciate that all or part of systems and methods consistent with the present invention may be stored on or read from other computer-readable media, for example, secondary storage devices such as hard disks, floppy disks, and CD-ROMs; a signal received from a network such as the Internet; or other forms of ROM or RAM either currently known or later developed. Further, although specific components of data processing system 100 are described, one skilled in the art will appreciate that a data processing system suitable for use with methods, systems, and articles of manufacture consistent with the present invention may contain additional or different components.

As will be explained in more detail below, the file service program 118 creates files with file names that include the data to be stored. The files may be created in a formal file system (e.g., in the memory 106 or in secondary storage 108) or without reliance on a formal file system.

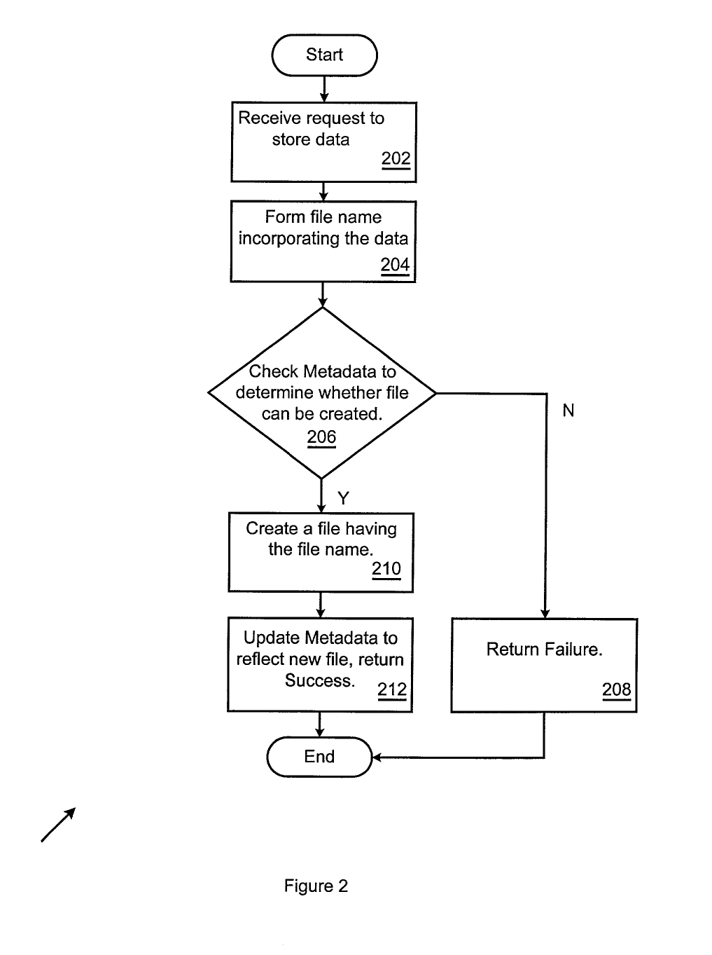

Turning to FIG. 2, that figure shows a flow diagram of processing performed by the file service program running in the data processing system shown in FIG. 1. The file service program 118 receives a request (e.g., from the program 116) to store predetermined data (step 202). As an example, the program 116 may request that the file service program 118 store the name of an author (e.g., “Nigel Derrick”) of a document currently being prepared by the program 116.

The file service program 118 then forms a file name that incorporates the predetermined data (step 204). For example, the file service program may form the file name “Nigel Derrick” in response to the request.

The file service program 118 proceeds to check the metadata to determine whether the file service program 118 can perform the file creation request (step 206). The metadata is data typically, though not necessarily, maintained in the data processing system 100 and characterizes the files that the file service program 118 stores in a memory or in a file system. As an example, metadata may include a table of contents for a fixed disk, file names and directory paths to the files, file attributes (e.g., read only, write only or read/write), file size, starting position on the disk, access permissions, number of processes with the file open, last access time and date, last modification time and date, and the like.

In certain instances, the metadata may indicate that the file service program 118 cannot create the file. As examples, the metadata may indicate that a file already exists with the same name and is write protected, that the file system cannot allocate additional storage for file entries, that a process already has a file open with the same name, or that the file is otherwise locked. When the file service program 118 cannot create the file, the file service program 118 returns a failure indication (e.g., by returning a predetermined value, sending a failure message, and the like) to the program 116 (step 208).

Otherwise, using the file name formed, the file service program 118 creates a file having the file name formed in step 204 (step 210). Thus, for example, the file service program 118 may create a file named “Nigel Derrick”. To that end, the file service program 118 may issue system calls that handle the file creation process in a file system. The file may be a zero-length file, although the file service program 118 may also write additional information in the file, if desired. Note, however, that the file name itself includes at least a portion of the data being stored.

After the file service program 118 creates the file, the file service program 118 updates the metadata for the file and returns a success indicator (e.g., by returning a preselected value, sending a success message, and the like) to the program 116 (step 212). As examples, the file service program 118 may add data to the metadata to record that an additional file now exists in the file system, add the file name to the table of contents, set the file permissions, creation date, and file attributes. Thus, in one embodiment, the file service program 118 may set the file name field f1 in the data structure 120 to reflect the name of the new file created.

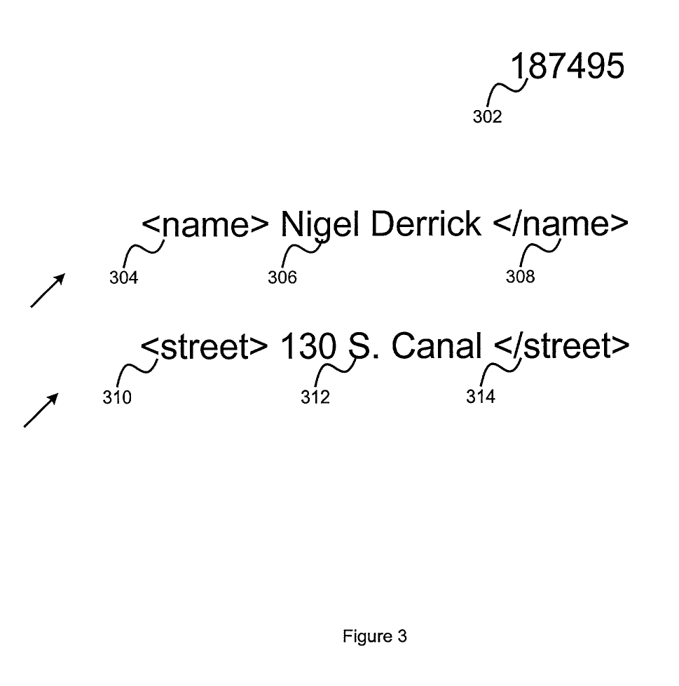

As noted above, the file service program 118 forms a file name that incorporates the data to be stored. With regard next to FIG. 3, that figure shows several examples of file names formed by the file service program 118. The file name 302 is a process identifier, specifically in this example process number 187495 assigned to a program running in the data processing system 100. The program 116 supplied the process identifier as the data to be stored, and the file service program 118, rather than storing the process identifier in a file, stored the process identifier using a file with a name that incorporated the process identifier.

As a result, when any program needs to retrieve the process identifier, the file service program 118 retrieves metadata that includes the file name, and returns the file name using (as examples) a pointer or handle to the program. In other words, the file service program 118 need not incur the overhead of updating metadata to reflect actual access to the file (since the file itself will not be opened); need not incur the overhead of updating internal tables that show the state of open files, allocate I/O buffers, and the like; need not issue system calls to perform file I/O (such as set-position and read); and need not make preparations for exclusive access to the file (such as setting locks and mutexes); and need not incur the overhead of closing the file, flushing buffers, deallocating memory, and the like.

In one implementation, the file service program 118 forms the file name using extensible Markup Language (XML) tags provided for by the XML specification promulgated by the World Wide Web Consortium. The tags generally include an opening label, the data, and a closing label. The opening and closing labels provide an identification of the type of data between the labels.

As an example, the file name 303 includes the opening label <name>, the data “Nigel Derrick”, and the closing label </name>. The complete file name is “<name> Nigel Derrick </name>”. Thus, a program that receives the file name 303 not only receives the data “Nigel Derrick”, but also receives labels that delineate and identify the data as a name. A second example is also provided in FIG. 3. The file name 309 includes the opening label <street>, the data “130 S. Canal”, and the closing label </street>. The program that receives the file name “<street> 130 S. Canal </street>” can then examine the labels to determine that the file name includes data setting forth a street address.

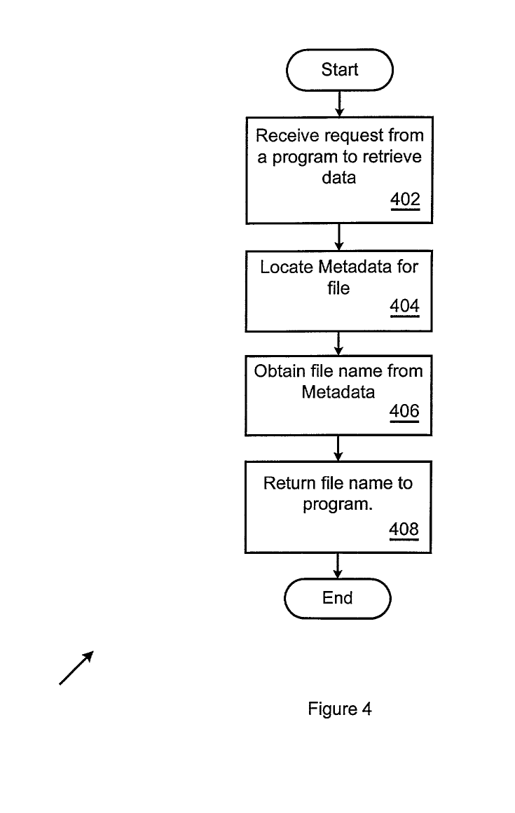

When the file service program 118 retrieves file name data for a program, the file service program 118 generally proceeds as shown in FIG. 4. First, the file service program 118 receives a request from a program to retrieve data (step 402). To that end, the program may request the name of all the files in a directory known to store certain types of data (e.g., a directory assigned to store customer names) in conjunction with the data storage technique described above. In effect, the program thereby requests all the data stored by those file names in a certain directory. The file service program 118 then locates the metadata for the file (step 404) and obtains the file names from the metadata (step 406). Having obtained the file names, the file service program 118 returns the file name to the requesting program (step 408). To that end, the file service program 118 may, as examples, return a pointer or a handle to the file name (or to the data structure 120 entries) to the program.

Note that a program may specifically indicate (e.g., using a message parameter, a specific file service program function call, and the like) that the file service program 118 should retrieve only a file name, as opposed to actually opening and reading from the file. Additionally, however, the file service program 118 may infer that file name access is desired. As an example, if the program 116 requests data associated with a zero-length file, then the file service program 118 may respond by returning only the file name to the requesting program, rather than opening the file itself.

Thus, methods and systems, as embodied and broadly described herein, include creating files with names that (in and of themselves) store data for later retrieval. As a result, a file service program need only retrieve metadata (such as a table of contents) to obtain the required data. For that reason, the methods and systems accelerate retrieval of data by avoiding significant overhead that would be required for a conventional file system to read data from a file. A program need not incur the overhead to create a new file, place the data in the file, and later reopen the file and reread the data. Rather, methods and systems consistent with the present invention may obtain the data without actually opening and reading the file.

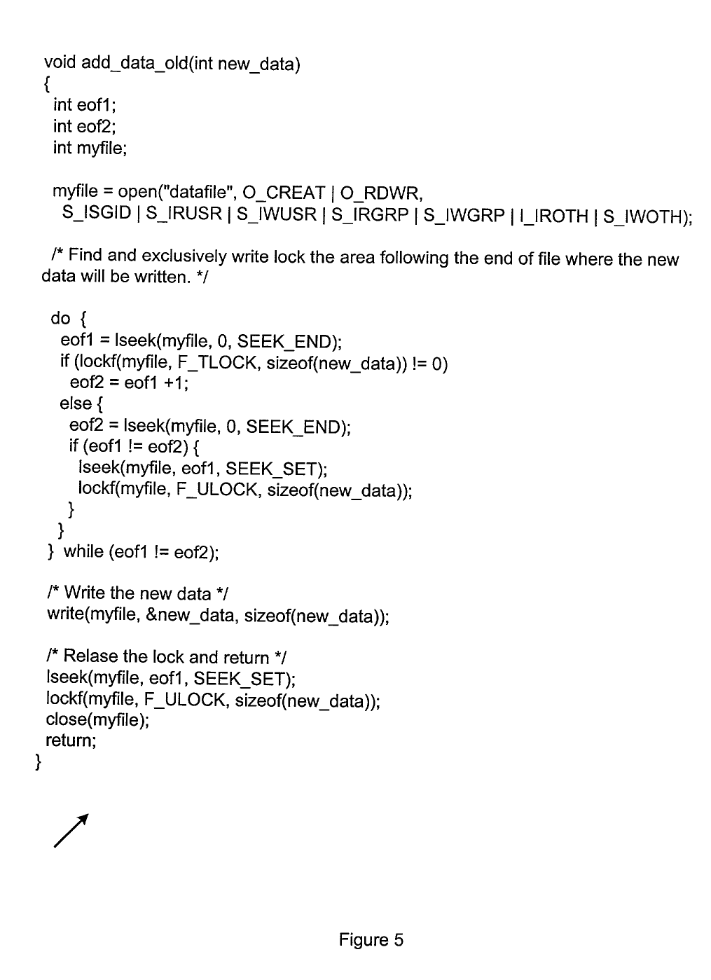

As a specific example, note that the overhead and drawbacks associated with file locking may be avoided. For example, in many UNIX systems, a process may lock a file using the C function lockf( ). However, the process may not use a lock in every instance (thereby allowing other files to access the file improperly), or may hold the lock for undue periods of time, thereby stalling or deadlocking other programs waiting for access to the file. The lockf( ) function is also incompatible with common and efficient buffered I/O (as noted in the documentation for lockf( )), and may not provide compatible behavior across all platforms. FIG. 5, for example, depicts an example of such a routine 500 that stores integer data in a file, rather than in a file name.

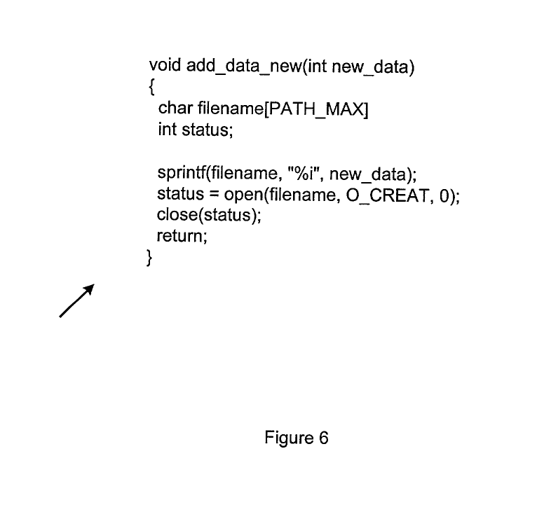

This fast access system, however, does not suffer from any of the foregoing drawbacks because all locking and access control, when needed, is enforced by the file system using mechanisms already incorporated into conventional file systems. Thus, the internal locks typically apply to all processes that use the file system, the file system will not hold locks for excessive periods of time, and the locks work with all types of I/O. In contrast to the relatively complex routine shown in FIG. 5, FIG. 6 depicts an example of a much less complex routine 600 that the file service program 118 may use to store integer data in a file name, rather than in a file.

As noted above, the file service program 118 may be incorporated into the program 116 as file service routines. The file service routines in the program 116 may function in the same manner as the file service program 118, including creating the file names and executing the functions that create a file, without passing the data to be stored to a separately executing file service program 118. In such an implementation, the program 116 may receive a request to store data through user input, including mouse clicks, keystrokes, and the like.

The foregoing description of an implementation of the invention has been presented for purposes of illustration and description. It is not exhaustive and does not limit the invention to the precise form disclosed. Modifications and variations are possible in light of the above teachings or may be acquired from practicing of the invention. For example, the described implementation includes software but the present invention may be implemented as a combination of hardware and software or in hardware alone. Note also that the implementation may vary between systems. The invention may be implemented with both object-oriented and non-object-oriented programming systems. The claims and their equivalents define the scope of the invention.

What is claimed is:

1. A method in a data processing system for storing data, the method comprising the steps of:
receiving a request to store predetermined data;
forming a file name comprising the predetermined data; and
creating a file with the file name.

2. The method of claim 1, wherein the step of forming comprises the step of forming the file name comprising the predetermined data, and an opening label and a closing label that identify a data type for the predetermined data.

3. The method of claim 1, wherein the step of forming comprises the step of forming the file name comprising the predetermined data and an XML opening label and a n XML closing label.

4. The method of claim 1, wherein the step of creating a file comprises the step of creating the file with the file name on a secondary storage device.

5. The method of claim 1, further comprising the step of adding characterizing data for the file to metadata maintained in the data processing system.

6. The method of claim 1, wherein the step of adding characterizing data comprises the step of adding the file name and a directory path to the file to metadata maintained in the data processing system.

7. A computer-readable medium containing instructions that cause a data processing system to perform a method for storing data, the method comprising the steps of:
receiving a request to store predetermined data;
forming a file name comprising the predetermined data; and
creating a file with the file name.

8. The computer-readable medium of claim 7, wherein the step of forming comprises the step of forming the file name comprising the predetermined data and an opening label and a closing label that provide an identification of the type of predetermined data.

9. The computer-readable medium of claim 7, wherein the step of creating a file comprises the step of creating the file with the file name on a secondary storage device.

10. The computer-readable medium of claim 7, wherein the method further comprises the step of adding the file name and a directory path to the file to metadata maintained in the data processing system.

11. The computer-readable medium of claim 7, wherein the step of creating the file comprises the step of creating a zero-length file with the file name.

12. A data processing system comprising:
a memory comprising a file service program, the file service program for receiving a request to store predetermined data, forming a file name comprising the predetermined data, and creating a file with the file name; and
a processor that runs the file service program.

13. The data processing system according to claim 12, further comprising metadata stored in the memory, the metadata comprising the file name and a directory path to the file.

14. The data processing system according to claim 12, wherein the file is a zero-length file.

15. The data processing system according to claim 12, wherein the file name further comprises an opening tag and a closing tag that identify a data type for the predetermined data.

16. The data processing system according to claim 15, wherein the file name comprises the opening tag, followed by the predetermined data, followed by the closing tag.

17. The data processing system according to claim 15, wherein the memory comprises a hard disk.

18. A data processing system comprising:
means for receiving a request from a program to store predetermined data;
means for forming a file name incorporating the predetermined data; and
means for running a file service program to create a file with the file name.

19. A computer-readable memory device encoded with a data structure created by a file service program that is encoded in the computer-readable memory device and that is run by a processor in a data processing system, the data structure comprising entries, each entry associated with a file and each entry comprising:
a file name field comprising a file name comprising data to be stored by a program.

20. A computer readable-memory device according to claim 19, wherein each entry further comprises a directory path field for storing a directory path to the file.

21. A method in a data processing system for storing data, the method comprising the steps of:
receiving, by a file service program, a request submitted by a requesting program to store predetermined data in a file system;
forming a file name comprising the predetermined data;
analyzing metadata stored in the data processing system to determine whether a file with the file name can be created in the file system;
when the file can be created, adding the file name to file system metadata stored in the data processing system, creating the file in the file system, and returning a success indication to the requesting program; and
when the file cannot be created, returning a failure indication to the requesting program.

22. The method of claim 21, wherein the step of forming comprises the step of forming the file name comprising the predetermined data, and an opening label and a closing label that identify a data type for the predetermined data.

23. The method of claim 21, wherein the step of forming comprises the step of forming the file name comprising the predetermined data, and an XML opening label and an XML closing label.

24. The method of claim 21, wherein the step of creating the file comprises the step of creating a zero-length file in the file system.

25. The method of claim 21, wherein the step of adding the file name to file system metadata further comprises the step of adding a directory path to the file to the file system metadata.
